(19) United States
(12) Patent Application Publication
(10) Pub. No.: US 2023/0308180 A1
(43) Pub. Date: Sep. 28, 2023

(54) ACQUISITION SCHEMES FOR DETECTION OF DIRECTIONAL WIRELESS COMMUNICATION SYSTEM

(71) Applicant: KING ABDULLAH UNIVERSITY OF SCIENCE AND TECHNOLOGY, Thuwal (SA)

(72) Inventors: Mohamed-Slim ALOUINI, Thuwal (SA); Muhammad Salman BASHIR, Thuwal (SA)

(21) Appl. No.: 18/021,612

(22) PCT Filed: Aug. 11, 2021
(86) PCT No.: PCT/IB2021/057416

§ 371 Date: Feb. 16, 2023

Related U.S. Application Data
(60) Provisional application No. 63/066,522, filed on Aug. 17, 2020.

(51) Int. Cl. H04B 10/112

(52) U.S. Cl. CPC H04B 10/1123

(57) ABSTRACT

A terminal is configured to communicate with another terminal using an optical link. The terminal includes an optical transmitter configured to emit an optical beam, an optical receiver configured to receive an optical signal, and a computing device configured to control the optical transmitter and to receive the optical signal from the optical receiver. The computing device is configured to establish the optical link with the another terminal by, (1) dividing an area of uncertainty, where the another terminal is located, into one spherical region [symbol] ( [symbol] ₁) and an annulus ring [symbol] ( [symbol] ₂)− [symbol] ( [symbol] ₁), wherein each of [symbol] ( [symbol] ₁) and [symbol] ( [symbol] ₂) are spherical regions with radii [symbol] ₂> [symbol] ₁, (2) scanning first the spherical region [symbol] ( [symbol] ₁) with the optical beam, and (3) scanning second the spherical region [symbol] ( [symbol] ₁) and the annulus ring [symbol] ( [symbol] ₂)− [symbol] ( [symbol] ₁) with the optical beam.

### CROSS-REFERENCE TO RELATED APPLICATIONS

This application claims priority to U.S. Provisional Patent Application No. 63/066,522, filed on Aug. 17, 2021, entitled “ADAPTIVE ACQUISITION SCHEMES FOR LOW PROBABILITY OF DETECTION DIRECTIONAL WIRELESS COMMUNICATIONS,” the disclosure of which is incorporated herein by reference in its entirety.

### BACKGROUND

### Technical Field

Embodiments of the subject matter disclosed herein generally relate to a system and method for initiating and maintaining an optical channel between two terminals, and more particularly, to geographically locating a receiver terminal, in a communication network, with a transmitter terminal by using an adaptive acquisition scheme and to establishing an optical communication between the transmitter and receiver terminals.

### Discussion of the Background

Acquisition and tracking systems form an important component of free-space optical communication systems due to the directional nature of the optical signals. Acquisition subsystems are needed in order to search and locate a receiver terminal in an uncertainty/search region with very narrow laser beams. Free-space optical (FSO) communications is a promising technique that can provide high data-rates for the next generation of wireless communication systems. Because of the availability of large chunks of unregulated spectrum available in the optical domain, high-speed data communications can be achieved with FSO systems. These systems have typically been used in deep space communications where the long link distances dictate that the transmitted energy be focused to achieve a small angle of divergence.

However, more recently, large Internet-based services providing corporations are employing FSO in the backhaul network in order to provide connectivity to regions of the world that still lack internet access. As shown in FIG. 1, because of the narrow beamwidth associated with the optical signal 110 transmitted by a transmitter terminal 102 to a receiver terminal 104, as is the case for any “directional” communication system, such as Terahertz and millimeter wave systems, acquisition and tracking subsystems are needed in order to establish and maintain a communication link 112 between the transmitter and the receiver terminals, respectively. Note that in FIG. 1, the transmitter and receiver terminals are not aligned, and thus, the communication link 112 has not been established (for this reason, the link is indicated by a dash line). Acquisition is the process whereby the two terminals 102 and 104 obtain each other's location in order to effectively communicate in a directional communications setting, i.e., to orient their respective beams 110 and 114 along the communication link 112.

Various acquisition schemes exist for aligning terminals for establishing optical channels. An example of a nonadaptive scheme is the spiral search that is argued to be optimal for a Rayleigh distributed receiver location in the uncertainty region, and outperforms other scanning approaches when the probability of detection is high. However, for photon-limited channels that incur a small probability of detection, this scheme does not perform as well.

Photon-limited channels exist in deep space communications where the long link distances result in a significant reduction of the received signal photons. Additionally, such channels also exist in terrestrial FSO where the presence of fog or clouds results in a significant attenuation of the transmitted energy. Because of low numbers of received signal/receiver noise photons, the probability of detection for a Pulse Position Modulation (PPM) or On-Off Keying (OOK) receiver is very poor. This also affects the acquisition performance since a successful acquisition depends on detection probability of the transmitted pulse at the receiver. For the spiral scan, such low photon-rate channels will lead to several scans of the uncertainty region before the terminal is discovered. This wastes both time and energy during the acquisition stage.

In addition to low photon rates, the probability of detection also suffers from a desire to achieve a low probability of false alarm during the acquisition stage. A reasonably low probability of false alarm is needed so that the system does not “misacquire” the terminal: that is, the transmitter mistakenly decides that the receiver has been located in the uncertainty region, and begins to transmit data in the “wrong” direction. This misacquisition wastes energy and time, and results in restarting the acquisition process after the misacquisition event is detected.

Therefore, during the detection process in the acquisition stage, it is necessary to set the threshold high enough in order to set the probability of false alarm reasonably low. However, setting the threshold higher than usual also results in a lower probability of detection. After the acquisition stage is completed successfully, the threshold can be lowered in order to increase the probability of detection (or minimize the probability of error) for the purpose of decoding data symbols. The photon counting channel is modeled by a Poisson Point Process (PPP).

If the acquisition problem in FSO is treated purely as a signal processing/probabilistic matter, the following approaches are known in the art. A first reference [1] discloses realizing a secure acquisition between two mobile terminals. The idea is to use a double-loop raster scan so that the reception of the signal and the verification of identities through a IV code can be carried out in rapid succession. This approach uses an array of detectors at the receiver that acts both as a bearing/data symbol detector. The acquisition time is optimized in terms of signal-to-noise ratio and beam divergence among other parameters.

A second reference [2] discloses optimizing the acquisition time as a function of the uncertainty sphere angle. Instead of scanning the entire uncertainty region, the idea is to scan a subregion of the uncertainty sphere that contains the highest probability mass. This is done in order to save time. The acquisition is carried out for a mobile satellite scenario, whose location coordinates at a certain point in time, obtained through ephemeris data, is designated as the center of the uncertainty sphere. The spiral scanning technique is used to locate the satellite. Instead of searching the whole sphere (three standard deviations for a Gaussian sphere), this reference searches a fraction of the region (which is 1.3 times the standard deviation). If the satellite is missed in one search, the hope is that it will be located in the next search, and so on.

The third reference [3] describes a signal acquisition technique for a stationary receiver that employs an array of small detectors. This reference concludes that an array of detectors minimizes the acquisition time as compared to one single detector of similar area as an array. This reference also considers the possibility of multiple scans of the uncertainty region in case the receiver is not acquired after a given scan. An upper bound on the mean acquisition time is optimized with respect to the beam radius, and the complementary cumulative distribution function of the upper bound is computed in closed-form.

There is another body of work that discusses improvements in acquisition/tracking performance by offering hardware-based solutions. In this regard, one reference proposes to improve the tracking performance with the help of camera sensors that direct the movement of control moment gyroscopes (CMG) in order to control a bifocal relay mirror spacecraft assembly. The main application of this work is to minimize the jitter/vibrations in the beam position using CMG's and fine tracking using fast steering mirrors. Another reference adopts gimbal less Micro-Electro-Mechanical Systems (MEMS) micro-mirrors for fast tracking of the time-varying beam position. Still another reference examines the acquisition performance of a gimbal based pointing system in an experimental setting that utilizes spiral techniques for searching the uncertainty sphere. However, all these known methods are still slow.

Thus, there is a need for a new system and method that is capable of aligning two terminals for establishing an optical link in a quicker time interval.

### BRIEF SUMMARY OF THE INVENTION

According to an embodiment, there is a terminal configured to communicate with another terminal using an electromagnetic link. The terminal includes an optical transmitter configured to emit an optical beam, an optical receiver configured to receive an optical signal, and a computing device configured to control the optical transmitter and to receive the optical signal from the optical receiver. The computing device is configured to establish the optical link with the another terminal by, (1) dividing an area of uncertainty, where the another terminal is located, into one spherical region [symbol] ( [symbol] ₁) and an annulus ring [symbol] ( [symbol] ₂)− [symbol] ( [symbol] ₁), wherein each of [symbol] ( [symbol] ₁) and [symbol] ( [symbol] ₂) are spherical regions with radii [symbol] ₂> [symbol] ₁, (2) scanning first the spherical region [symbol] ( [symbol] ₁) with the optical beam, and (3) scanning second the spherical region [symbol] ( [symbol] ₁) and the annulus ring [symbol] ( [symbol] ₂)− [symbol] ( [symbol] ₁) with the optical beam.

According to another embodiment, there is a method for aligning a terminal with another terminal for establishing an optical link. The method includes receiving at the terminal an estimated location of the another terminal, establishing an area of uncertainty around the estimated location of the another terminal, dividing, with a computing device of the terminal, the area of uncertainty into one spherical region [symbol] ( [symbol] ₁) and an annulus ring [symbol] ( [symbol] ₂)− [symbol] ( [symbol] ₁), wherein each of [symbol] ( [symbol] ₁) and [symbol] ( [symbol] ₂) are spherical regions with radii [symbol] ₂> [symbol] ₁, generating an optical beam with a transmitter of the terminal, scanning with the optical beam only the spherical region [symbol] ( [symbol] ₁) to locate the another terminal, scanning again the spherical region [symbol] ( [symbol] ₁) and the annulus ring [symbol] ( [symbol] ₂)− [symbol] ( [symbol] ₁) with the optical beam to determine an actual location of the another terminal, and orienting the terminal toward the another terminal, based on the actual location, to establish the optical link.

A method for aligning a terminal with another terminal for establishing an optical link includes receiving at the terminal an estimated location of the another terminal, establishing an area of uncertainty around the estimated location of the another terminal, selecting random positions inside the area of uncertainty, generating an optical beam with a transmitter of the terminal, scanning with the optical beam the random positions to determine an actual location of the another terminal, and orienting the terminal toward the another terminal to establish the optical link, based on the actual position of the another terminal.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a system of two terminals that exchange information along an optical link;

FIG. 2 schematically illustrates how one terminal of the system scans an uncertainty region to find the other terminal;

FIG. 3 schematically illustrates how the uncertainty region is scanned following a single spiral;

FIG. 4 schematically illustrates the configuration of a terminal;

FIGS. 5A and 5B schematically illustrate how the uncertainty region is scanned multiple times for finding the another terminal;

FIG. 6 is a flow chart of an adaptive acquisition scheme for finding the another terminal;

FIG. 7 schematically illustrates a shotgun acquisition scheme for finding the another terminal;

FIG. 8 is a flow chart of a method for finding the another terminal using a random approach;

FIG. 9 shows an average acquisition time as a function of a number of subregions N when the radii of the subregions are uniformly distributed between 0 and a maximum value, for different values of a probability of detection;

FIG. 10 shows a complementary cumulative distribution function as a function of a number of subregions N when the radii are uniformly distributed between 0 and a maximum value, for different values of the probability of detection;

FIG. 11 shows the average acquisition time as a function of a number of subregions N for optimized and nonoptimized cases;

FIG. 12 shows the complementary cumulative distribution function as a function of a number of the subregions N for the optimized and nonoptimized cases;

FIG. 13 shows the average acquisition time as a function of a standard deviation of a firing distribution for a shotgun approach;

FIGS. 14A and 14B show the complementary cumulative distribution function as a function of the standard deviation of the firing distribution for different values of the probability of detection and a time threshold, respectively;

FIG. 15 shows the average acquisition time as a function of the probability of detection for the optimized shotgun and adaptive spiral schemes;

FIG. 16 shows the complementary cumulative distribution function as a function of the probability of detection for the optimized shotgun and adaptive spiral schemes; and

FIG. 17 is a schematic diagram of a computing device that may be used to implement the methods discussed herein.

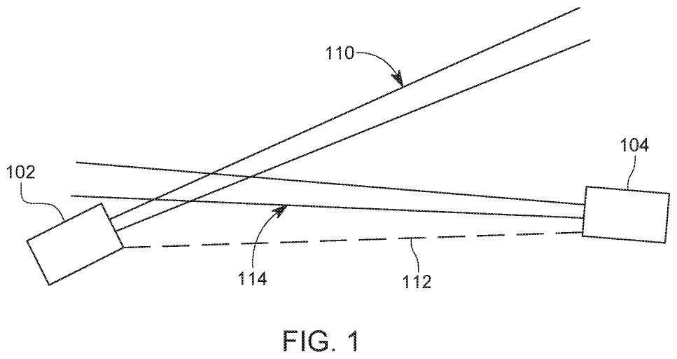

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to two terminals that have optical transceivers. However, the embodiments to be discussed next are not limited to a system having two terminals, or only to optical transceivers, but may be applied to other systems and to any electromagnetic beams that are generated/received by electromagnetic transceivers. Even though the discussion in the next embodiments pertains to free-space optical communications, the novel concepts discussed herein are general enough and apply to any high-frequency and directional (narrow beam) wireless communications schemes such as Millimeter and Terahertz wave systems. Thus, one skilled in the art would be able, based on the following embodiments, to extend the discussed systems to the Terahertz system, which is expected to be adopted for 6G wireless communications.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, an adaptive acquisition scheme divides the uncertainty region (i.e., the region where one terminal expects to find the other terminal) into a number of smaller subregions, and the subregions that correspond to the higher probability mass of the receiver's location are searched more frequently than the others. Note that in the following, the terminal that searches for the other terminal is called the transmitter and the terminal that is searched for is called the receiver, although each terminal has a transmitter and a receiver, i.e., a transceiver. Also, in the following, it is assumed that one terminal is searching for the other terminal when in practice each terminal may be searching for other terminals. An advantage of this scheme is if the receiver is not discovered during the search of a subregion that has a higher probability mass attached to it, then there is a higher chance that the transmitter missed the receiver due to a low probability of detection, and the transmitter can achieve a better performance if the transmitter rescans this particular subregion a few times before the transmitter moves on to explore subregions of lower probability mass. The scanning is done by searching along a spiral, and a significantly better performance can be obtained by optimizing the volumes of the subregions. This scheme is called the adaptive spiral search technique.

In another embodiment, a shotgun scheme is proposed, and this scheme is a randomized acquisition scheme. In the shotgun approach, the uncertainty region is scanned at locations that are sampled from a Gaussian distribution (also called the firing distribution). By choosing the suitable variance of the firing distribution, the acquisition time can be minimized.

For a low probability of detection, both these schemes provide a better acquisition time performance than the spiral search scheme given in [2] and [3], as discussed later. The adaptive spiral search technique significantly outperforms the shotgun approach. However, the cost that the system pays with this approach is the requirement to meet ultra-precise pointing of the beam on the spiral during scanning process. In contrast, the shotgun approach can be implemented without stringent requirements on the pointing accuracy.

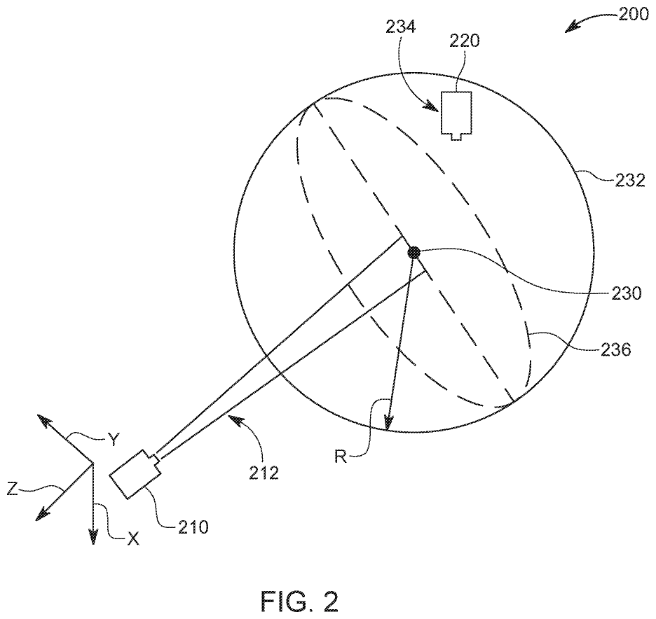

These novel acquisition schemes are now discussed in more detail. Common to both schemes is the uncertainty region, or uncertainty sphere, or the search region, which is defined as being a volume in space that is scanned by the initiator/transmitter terminal to locate the receiver terminal to establish a communication link. This configuration (system 200) is illustrated in FIG. 2 and includes a transmitter terminal 210 and a receiver terminal 220. Note that more than two terminals may be part of the system 200, but only two are shown for simplicity. Also, note that although one terminal is called “transmitter” or “receiver,” each terminal is equipped to act both as a transmitter and receiver, i.e., each terminal includes a transceiver.

The transmitter terminal 210 usually knows an expected position 230 of the receiver terminal 220, for example, based on the GPS coordinates of the receiver terminal, or the expected position of a satellite at a given time, but this position is inaccurate as the actual position 234 of the receiver terminal 220 is different from the expected position 230. Thus, the transmitter terminal 210 has to search a sphere 232 with radius R for determining the exact location 234 of the receiver terminal 220.

As discussed in the Background section, the errors in the measurements of the localization systems (e.g., GPS system), and the errors in the pointing assembly of the transmitter (i.e., the system that orients the optical beam 212 of the transmitter 210) determine the size of the volume 232 of the uncertainty region. It was observed that the larger the error variance, the greater the volume the transmitter has to scan in order to successfully complete the acquisition stage.

The error in two dimensions (i.e., in the XY plane in FIG. 2, where X is perpendicular to the plane of the paper and the Y and Z axes are in the plane of the paper) in the uncertainty region 232 is modeled in this embodiment by a two dimensional Gaussian distribution. Note that while FIG. 2 shows a cartesian system of reference XYZ, a spherical system of reference may be used. The same is true for the Gaussian distribution, i.e., in another embodiment, another distribution may be used. Also note that a circumference 236 of the sphere 232 shown in FIG. 2 extends in the XY plane, i.e., the axis Z is perpendicular to the area encompassed by the circumference 236. If the error of the actual position 234 of the receiver terminal 220 in each dimension is assumed to be independent and with equal variance, the resulting error distribution is a circularly symmetric Gaussian distribution, and the distance from the center 230 of the sphere 232 to the receiver terminal 220 may be modeled as a Rayleigh distributed random variable.

For the spiral scan technique, the acquisition time in this case becomes tractable to analyze because the time it takes to start from the center 230 of the uncertainty region 232 until arriving at the point 234, where the receiver 220 is located, is modeled approximately by an exponential distribution, for the successful detection scenario. However, as discussed in [3], the uncertainty region 232, in general, is represented by a general (elliptical) Gaussian distribution in two dimensions (correlated Gaussian errors in two dimensions with unequal variance). Nevertheless, as argued in [3], if the general error covariance matrix is known, any elliptical uncertainty region can be transformed to a circular uncertainty region by using an appropriate linear transformation, and the probability distribution of the acquisition time in the circular uncertainty region case is the same as the acquisition time distribution in the elliptical case.

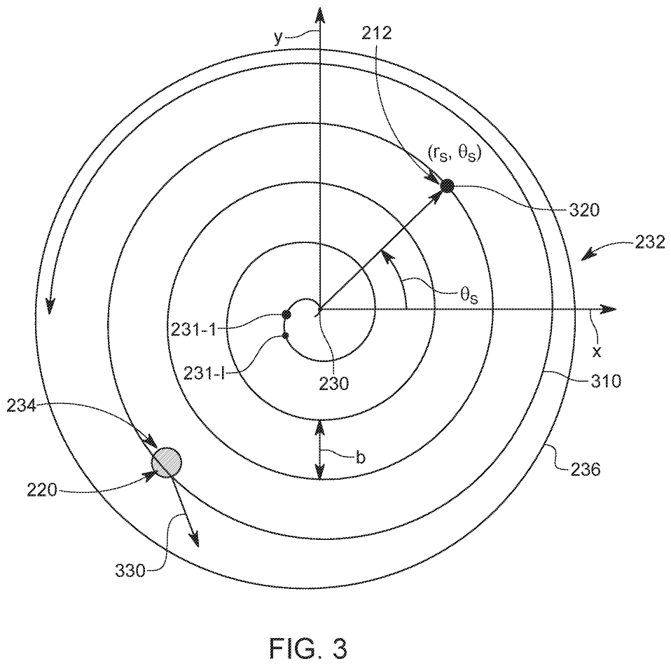

For a circular uncertainty region 236, as shown in FIG. 3, a search technique that uses an Archimedean spiral 310 provides an optimal performance in terms of the acquisition time [2]. Since the spiral search scans the contours of higher probability mass first (i.e., the region closer to the center 230) as opposed to contours of lower probability (i.e., the region furthest from the center 230), it is easy to see why the spiral search will perform better than other search techniques for a circular uncertainty region 232. FIG. 3 shows the spiral path 310 followed for scanning the entire circular uncertainty region 236 of the sphere 232. For a general (elliptical) uncertainty sphere 232, the spiral scan method will be replaced by a similar technique that starts the scan from the center 230, and then moves outward along elliptical contours 310 of the Gaussian distribution. The current location 320 of the beam 212 (note that the point 320 in FIG. 3 shows the cross-section of the beam 212, which indicate that the beam is pretty focused and it is unlikely at this position to communicate with the terminal 220) while scanning the sphere 232, i.e., following the path 310, is shown in the figure as being described by a radius rₛ, and an angle θₛ, where the radius rₛ is measured in the plane XY, from the center 230 of the circumference 236, while the angle θₛ measures the position of the radius rₛ in the XY plane, relative to the X axis. Note that in FIG. 2, the transmitter terminal 210 is above the circumference 236, on the Z axis, and its beam 212 is scanning the plane XY, inside the circumference 236, following the path 310. Because the beam 212 is an optical beam, for example, a laser beam, the beam's spread is very small, and thus, different from an RF signal, which spreads everywhere from the generation point, the beam 212 needs to be aligned with the location of the receiver 220 in order to establish a communication link. In other words, the configuration shown in FIG. 3 did not establish a communication link as the beam 212 is far away from the actual location 234 of the receiver terminal 220.

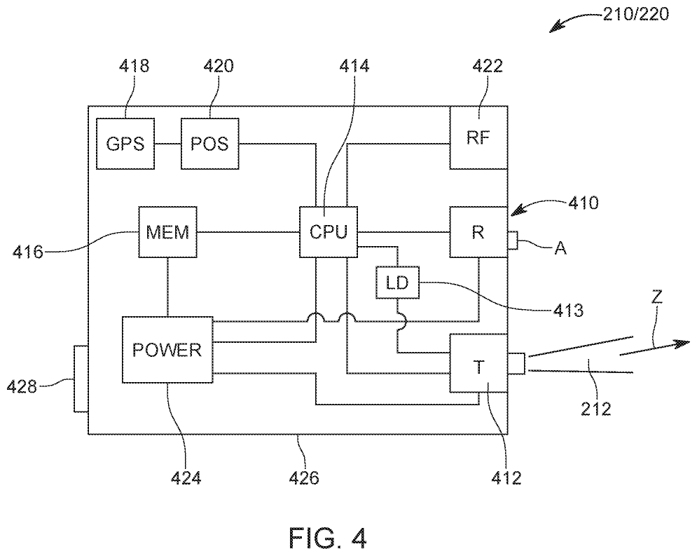

With these definitions of the uncertainty region and spiral scanning technique, the novel adaptive acquisition scheme is now discussed. To initiate the spiral scan, assume that terminal 210 will begin by pointing its transmitter 412 (see FIG. 4) towards the center 230 of the uncertainty region 232, by transmitting a pulse (beam 212) toward the center 230, and then listening for any feedback information from the receiver terminal 220. If the receiver terminal 220 detects the pulse, it will send a signal back to transmitter terminal 210, on a low data-rate radio frequency (RF) feedback channel 330, to confirm that the signal has been acquired. Otherwise, the receiver terminal 220 transmits no signal, and the transmitter terminal 210 will point to the next point 231-I on the spiral path 310 and transmit a new beam 212, and the process repeats itself until the receiver terminal 220 has been found. To generate the beam 212 at the desired points 232-I, the terminal 210, as shown in FIG. 4, includes a positioning system POS 420, which moves the entire terminal to point in new direction, or moves only the transmitter 412 to point in the new direction. The time that the receiver terminal 210 waits before transmitting the next pulse is known as the dwell time T_{d}, and this time interval takes into account factors such as the receiver processing time and the round-trip-delay time of the sent beam 212. Once the transmitter terminal 210 discovers the receiver terminal 220, the receiver terminal 220 starts the same process in order to locate the transmitter terminal 210. However, because the receiver terminal 220 now has information about the transmitter terminal 210's angle-of-arrival, the search region to locate the transmitter terminal 210 is much smaller. Thus, the total acquisition time is approximately the time that the transmitter terminal 210 requires in order to locate the receiver terminal 220.

The adaptive acquisition scheme uses a probability of detection measure for determining which path 310 to consider. In this regard, the transmitter terminal 210 decides whether the receiver terminal 220 is detected at a given point in the uncertainty region 236 by carrying out the following calculations:

$$\frac{p ( Z \vert {H}_{1} ) p ( {H}_{1} )}{p ( Z \vert {H}_{0} ) p ( {H}_{0} )} {≶}_{{H}_{0}}^{{H}_{1}} γ , \qquad ( 1 )$$

where p is a Poisson distribution, Z is the (random) photon count generated in the optical detector 410 (see a schematic diagram of the terminal 210 in FIG. 4) during an observation period, γ is a (positive) threshold, H₁ is the hypothesis that the terminal 220 is present at a given point in a sphere [symbol] ( [symbol] ) of radius [symbol] , and H₀ is the hypothesis that the receiver is not present. The probability of detection P_{D} for a maximum a posteriori probability (MAP) detector is given by:

$${P}_{D} = P ( \{ \frac{p ( Z \vert {H}_{1} )}{p ( Z \vert {H}_{0} )} > {γ}_{0} \} ) , \\ where p ( Z \vert {H}_{1} ) := \frac{{{e}^{- ( {λ}_{s} + {λ}_{n} ) AT} ( ( {λ}_{s} + {λ}_{n} ) AT )}^{Z}}{Z !} , \\ p ( Z \vert {H}_{0} ) := \frac{{{e}^{- {λ}_{n} AT} ( {λ}_{n} AT )}^{Z}}{Z !} , P ( {H}_{1} ) = \frac{r}{{σ}^{2}} {e}^{- \frac{{r}^{2}}{2 {σ}^{2}}} , r \geq 0 , \\ and P ( {H}_{0} ) = 1 - P ( {H}_{1} ) . \qquad ( 2 )$$

### Additionally,

$${γ}_{0} := γ \frac{P ( {H}_{0} )}{P ( {H}_{1} )} .$$

The parameter r is the distance from the center 230 of the uncertainty region 232 to the location of the transmitted beam 212 in the plane defined by the circumference 236. The quantity (λₛ+λₙ)AT refers to the mean photon count for the signal plus noise (H₁) hypothesis, and λₙ refers to the mean photon count for the noise only (H₀) hypothesis. The quantity A is the area of the detector 410, and T represents an observation interval. The constant γ is an appropriate threshold chosen for some fixed probability of false alarm, P_{FA}. In one embodiment,

$${P}_{FA} = P ( \{ \frac{p ( Z \vert {H}_{1} )}{p ( Z \vert {H}_{0} )} > {γ}_{0} \} ) ,$$

where p is the Poisson distribution with mean λₙAT.

The probability of detection P_{D} is a function of the signal power λₛAT. The intensity of light, λₛ, that is impinging on the detector 410 is usually assumed to have a Gaussian distribution in two dimensions. In order to simplify the analysis, the Gaussian function is approximated in this embodiment with a cylinder function, i.e., the light intensity is uniform over a circular region of radius ρ, which is considered to be the radius of the beam 212, and is zero elsewhere. Thus, for a constant transmitted signal power Pₛ, λₛ should drop as ρ is enlarged because Pₛ=λₛπρ², where Pₛ is the transmitted signal power. Thus, p(Z|H₁) becomes:

$$p ( Z \vert {H}_{1} ) := \frac{exp ( - ( \frac{{P}_{s}}{π {ρ}^{2}} + {λ}_{n} ) A T ) {( ( \frac{{P}_{s}}{π {ρ}^{2}} + {λ}_{n} ) A T )}^{Z}}{Z !} . \qquad ( 3 )$$

This shows that P_{D} is a function of the radius p through the dependence of p(Z|H₁) on the radius ρ. The probability of detection P_{D} can be analytically simplified by using a log-likelihood ratio, and a regularized Gamma function Q, so that

$${P}_{D} = 1 - Q ( ⌊ {γ}_{0} + 1 ⌋ , ( \frac{{P}_{s}}{π {ρ}^{2}} + {λ}_{n} ) AT ) , and {P}_{F A} = 1 - Q ( ⌊ {γ}_{0} + 1 ⌋ , {λ}_{n} AT ) . \qquad ( 4 )$$

While the description above referred only to the detector 410 of FIG. 4, this figure schematically shows the entire configuration of a terminal 210. More specifically, FIG. 4 shows that the terminal 210 or 220 includes, in addition to the receiver 410, which may be any light sensor, the transmitter 412, which may be, for example, a laser, a laser diode, a light emitting diode, etc. In one application, a laser device 413 may be provided in the terminal and the laser beam is directed to the transmitter 412, which may include some optics for controlling a direction of the optical beam. The transmitter 412 is controlled by a processor 414, which uses a memory 416, for controlling other components of the terminal. The terminal may also include a GPS device 418, which may feed its data to a positioning system 420. The positioning system 420 is configured to change an orientation of the entire system or only the emitted beam 212 relative to a direction Z, so that the orientation of the beam 212 can be adjusted relative to the direction Z. In one application, the positioning system 420 calculates the various positions 231-I where the beam 212 should point to follow the spiral 310. Further, the terminal may include an RF transceiver 422 to communicate with another terminal or a general controller of the system. All these elements may be powered by a power source 424, for example, a battery or equivalent means. These components may be hold by a housing 426. An input/output interface 428 is located on the housing 426 and is configured to allow the operator of the terminal to interact with the various elements of the terminal. In one embodiment, the input/output interface 428 may include one or more of a keyboard, a screen, a mouse, and/or a communication port.

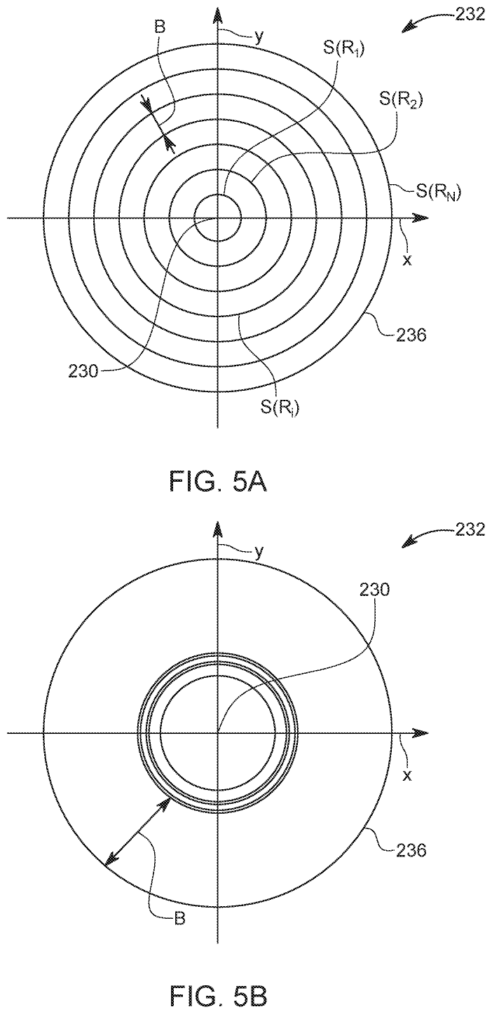

For the novel adaptive spiral search discussed in this embodiment, the uncertainty region 232 is divided into N smaller regions or subregions [symbol] ( [symbol] ᵢ) with i=0, . . . , N, where [symbol] ( [symbol] ᵢ) is a sphere, as shown in FIG. 5A, centered at the origin 230, with radius [symbol] ᵢ, and [symbol] ₀< [symbol] ₁< . . . < [symbol] _{N}, which implies that [symbol] ( [symbol] ₀)⊂ [symbol] ( [symbol] ₁)⊂ . . . [symbol] ( [symbol] _{N}). Additionally, [symbol] ₀:=0, [symbol] ( [symbol] ₀)=Ø, [symbol] := [symbol] _{N}, and [symbol] ( [symbol] _{N}) corresponds to the total uncertainty region 232. FIG. 5A shows the uncertainty region 232 divided into 7 subregions. However, any number equal to or larger than 2 may be used. Note that FIG. 5A shows a radius difference B between any two adjacent subregions being the same. However, as shown in FIG. 5B, this radius difference can be modified to be different for each pair of subregions, as discussed later.

The novel searching procedure illustrated in FIGS. 5A and 5B repeatedly searches one area for detecting the presence of the receiver while also searching a new area. More specifically, to locate the receiver, the transmitter begins scanning from the origin 230 (i.e., the center of [symbol] ( [symbol] )) and finishes scanning at [symbol] ( [symbol] 1) for the first iteration. The scanning during the first iteration is called a “subscan” because only a portion of the general uncertainty volume [symbol] ( [symbol] ) has been scanned. If the receiver is not detected in this attempt, the transmitter initiates the second subscan by starting again from the origin 230, and this time ends the scanning process when it has finished searching the entire region [symbol] ( [symbol] ²). This means that when the transmitter finishes searching the region [symbol] ( [symbol] ₂), it has scanned the region [symbol] ( [symbol] ₁) twice, once during the first subscan and once during the second subscan when also scanning the annular ring [symbol] ( [symbol] ₂)− [symbol] ( [symbol] ₁). Thus, the region [symbol] ( [symbol] ₁) gets scanned a total of two times, once during the first subscan and once during the second subscan, while the annular ring [symbol] ( [symbol] ₂)− [symbol] ( [symbol] ₁) is searched only once, during the second subscan, when the transmitter ends its second subscan. In a similar way, when the transmitter has finished scanning the region [symbol] ( [symbol] _{N}), region [symbol] ( [symbol] ₁) gets scanned N times, region [symbol] ( [symbol] ₂) gets scanned N−1 times, and so on. Note that the term “subscan” is used herein to indicate a search attempt corresponding to a particular region [symbol] ( [symbol] ₖ), smaller than the entire uncertainty region [symbol] ( [symbol] ), with k=1, . . . , N, and the term “a scan” is used to indicate that [symbol] ( [symbol] ₁) has been searched N times, [symbol] ( [symbol] ₂) has been searched N−1 times, and so on, until the entire region [symbol] ( [symbol] ) is searched once. In other words, a single scan in this embodiment includes N subscans, with the corresponding sub-regions being scanned a different number of times. If the receiver is not located during the first scan, the whole process is repeated until the time the receiver is located.

The time taken to subscan the smallest region [symbol] ( [symbol] ₁), a sphere in this embodiment, but other shapes may also be used, for the adaptive spiral scan is approximately given by

$${T}_{d} \frac{{ℛ}_{1}^{2}}{{ρ}^{2}} ,$$

where T_{d} is the dwell time. For this case, the probability for finding the receiver 220 inside the region [symbol] ( [symbol] ₁) is given by:

P(E₁)=P(Eₛ_{₁}∩E_{D}_{₁}), (5)

where E_{S}_{₁} is the event that the receiver is present inside the region [symbol] ( [symbol] ₁), and E_{D}_{₁} is the event that the receiver is detected in the region [symbol] ( [symbol] ₁). Moreover, E₁ is the event that the receiver is detected during the first attempt/subscan. Then, equation (5) can be rewritten as:

$$P ( {E}_{1} ) = P ( {E}_{{S}_{1}} ⋂ {E}_{{D}_{1}} ) = \frac{P ( {E}_{{S}_{1}} ⋂ {E}_{{D}_{1}} )}{P ( {E}_{{S}_{1}} )} P ( {E}_{{S}_{1}} ) = P ( {E}_{{D}_{1}} \vert {E}_{{S}_{1}} ) P ( {E}_{{S}_{1}} ) . \qquad ( 6 )$$

Similarly,

Eₖ=A₁∪A₂∪ . . . ∪Aₖ, (7)

where Eₖ is the event that the receiver is detected during the kth attempt/subscan. Let E_{S}_{ₖ} be the event that receiver is present inside the sphere 474), and E_{DS}_{ₖ} be the event that receiver is detected in the sphere Mk). The set Aᵢ, for i=1, . . . , k, is the event that the receiver lies in the set [symbol] ( [symbol] ᵢ)− [symbol] ( [symbol] ᵢ₋₁), and is not detected in (k−i) attempts, and detected in one attempt. The set [symbol] ( [symbol] ᵢ)− [symbol] ( [symbol] ᵢ₋₁) represents the difference set. It represents the annular ring formed by the difference of two concentric spheres: [symbol] ( [symbol] ᵢ) and [symbol] ( [symbol] ᵢ₋₁). It is noted that the sets Aᵢ₋₁ ∩Aᵢ=Ø because ( [symbol] ( [symbol] ᵢ)− [symbol] ( [symbol] ᵢ₋₁)) ∩ [symbol] ( [symbol] ᵢ₋₁)=Ø. Thus,

$$P ( {E}_{k} ) = {\sum }_{i = 1}^{k} P ( {A}_{i} ) . \qquad ( 8 )$$

It is assumed that the uncertainty in the location of the receiver is modelled by a zero-mean independent and identically distributed (i.i.d.) Gaussian random variables with variance σ². If E_{S}_{ₖ} is the event that the receiver is present in the sphere [symbol] ( [symbol] ₖ), then

$$P ( {E}_{{S}_{k}} ) {\int }_{0}^{{ℛ}_{k}} {f}_{R} ( r ) d r , k = 1 , … , N , where {f}_{R} ( r ) := \frac{r}{{σ}^{2}} {e}^{- \frac{{τ}^{2}}{{σ}^{2}}} , r > 0. \qquad ( 9 )$$

From equations (8) and (9) it follows that the probability of finding the receiver can be written as:

$$P ( {E}_{k} ) = {\sum }_{i = 1}^{k} [ P ( {E}_{{S}_{i}} \vert {{⋂}^{k - 1}}_{j = 1} {E}_{j}^{C} ) - P ( {E}_{{S}_{i - 1}} \vert {{⋂}^{k - 1}}_{j = 1} {E}_{j}^{C} ) ] {( 1 - {P}_{D} )}^{k - 1} {P}_{D} , \qquad ( 10 )$$

where P_{D}:=P(E_{D}_{₁}|E_{S}_{₁})==P(E_{D}_{ₖ}|E_{S}_{ₖ}). For a small probability of detection P_{D}, P(E_{Si}∩ⱼ₌₁^{k-1} Eⱼ^{C})≈P(E_{S}_{₁}) for i=1, 2, . . . , k. This means that for a small P_{D}, the observation that the receiver has not been located in the previous k−1 attempts does not alter the receiver's location distribution for the kth attempt. Based on this observation, equation (10) becomes

$$P ( {E}_{k} ) \approx {\sum }_{i = 1}^{k} [ P ( {E}_{{S}_{i}} ) - P ( {E}_{{S}_{i - 1}} ) ] {( 1 - {P}_{D} )}^{k - 1} {P}_{D} . \qquad ( 11 )$$

Next, F denotes an event that given the receiver is present in the uncertainty region [symbol] ( [symbol] ), the acquisition system fails to locate the receiver during one full scan of [symbol] ( [symbol] ) through the adaptive scheme discussed herein. Then,

$$P ( F ) = {\sum }_{k = 0}^{N - 1} [ P ( {E}_{{S}_{k + i}} ) - P ( {E}_{{S}_{k}} ) ] {( 1 - {P}_{D} )}^{N - k} , \qquad ( 12 )$$

where E_{S}_{₀}:=Ø, the empty set. Note that for a non-adaptive scheme, P(F)=1−P_{D}.

For a single scan of [symbol] ( [symbol] ), i.e., a scan that involves N subscans as discussed above, due to the low probability of detection, the method has to carry out a number of subscans before the receiver is discovered in the uncertainty region. The amount of time spent for the successful and final scan for locating the receiver is now evaluated, and it is considered to be represented by the random variable V. Then, V is a mixed random variable, and is defined as V:=Y+X, where X is the random amount of time it takes for the system to detect the receiver during a “successful” subscan, and Y represents the distribution of time that is “wasted” in unsuccessful subscans, during the final scan. It can be seen that the value or distribution of X will depend on the area of the region in which the successful detection of the receiver takes place. Thus, given that the receiver is detected during the kth subscan, it can be shown that the conditional pdf of X is represented by a truncated exponential distribution:

$${f}_{X} ( x \vert {E}_{k} ) = \frac{1}{{η}_{k}} α {exp}^{- α x} \cdot {[ 0 , {T}_{d} {R}_{k}^{2} / {ρ}^{2} ]}_{} ( x ) , \qquad ( 13 )$$

where [symbol] _{A}(x) is the indicator function over some measurable set A, and ηₖ is a normalization constant.

Before defining the distribution of Y, Rₖ is defined as Rₖ: =Σᵢ₌₁^{k} [symbol] ᵢ², with k=1, . . . , N. Then, the random variable Y has a discrete distribution, and takes on the following values

$$Y = {T}_{d} \frac{{R}_{1}}{{ρ}^{2}}$$

when the receiver is detected in the region

$$𝒮 ( {ℛ}_{2} ) , Y = {T}_{d} \frac{{R}_{2}}{{ρ}^{2}}$$

when the receiver is detected in the region [symbol] ( [symbol] ₃), and

$$Y = {T}_{d} \frac{{R}_{N - 1}}{{ρ}^{2}}$$

when the receiver is detected in the region [symbol] ( [symbol] ). If the acquisition process fails in the region [symbol] ( [symbol] ), then

$$Y = {T}_{d} \frac{{R}_{N}}{{ρ}^{2}} .$$

In other words, the distribution can be expressed as:

$${f}_{Y} ( y ) = {\sum }_{k = 0}^{N - 1} P ( {E}_{k + 1} ) δ ( y - {T}_{d} \frac{{R}_{k}}{{ρ}^{2}} ) + P ( F ) δ ( y - {T}_{d} \frac{{R}_{N}}{{ρ}^{2}} ) , y > 0 , \qquad ( 14 )$$

where δ(x) is the Dirac Delta function, and R₀:=0.

When the next subscan starts, the prior information about the location of the receiver inside the uncertainty region remains unchanged. This is true because of the low probability of detection argument as previously discussed. In other words, the value of Y at any point does not provide any additional information about X. Thus, the variables Y and X are treated as independent random variables. For this scenario, f_{V}(v)=f_{Y}*f_{X}(v), where “*” represents the convolution operator.

If the event F occurs, then multiple scans of the region [symbol] ( [symbol] ) are considered. For this case, the total acquisition time is T=W+V′. The random variable W represents the time it takes to complete multiple scans of the uncertainty region [symbol] ( [symbol] ) with the adaptive scheme, and is given by W:=Uβ_{N}, where

$${β}_{N} : = {T}_{d} \frac{{R}_{N}}{{ρ}^{2}} ,$$

and ∪ is a geometric random variable with success probability p:=P(F). The discrete distribution of W is as follows:

$${f}_{w} ( w ) = ( 1 - p ) {\sum }_{i = 0}^{∞} {p}^{i} δ ( w - i {β}_{N} ) . \qquad ( 15 )$$

The random variable V′ is a modified version of the random variable V, since V′ represents the amount of time taken in the final scan of the uncertainty region given that the successful detection of the receiver occurs in this particular scan, when the previous W scans have failed to locate the receiver. Thus, there is no possibility of a “failure” in the final scan. Therefore, the distribution of V′ is the same as the distribution of V given that the detection event, D, will occur in the final scan. That is f_{V′}=f_{V}(v|D) where f_{V}(v|D) can be obtained by using the law of total probability:

$${f}_{T} ( t ) = {\sum }_{t =}^{∞} {p}^{i} {\sum }_{k = 0}^{N - 1} P ( {E}_{k + 1} ) \frac{α}{{η}_{k + 1}} {e}^{- α ( r - {i β}_{N} - {β}_{k} )} \cdot {𝕀}_{[ i {β}_{N} + {β}_{k} , i {β}_{N} + {β}_{k + 1} ]} ( t ) , \qquad ( 16 )$$

$$where$$

$$α = \frac{{ρ}^{2}}{2 {T}_{d} {σ}^{2}} .$$

The average expected value [symbol] [T] and the complementary cumulative distribution of T are now calculated. The average expected value of the acquisition time T is given by:

$$𝔼 [ T ] = {\int }_{- ∞}^{∞} t {f}_{T} ( t ) = {\sum }_{t =}^{∞} {p}^{i} {\sum }_{k 0 = 0}^{N - 1} P ( {E}_{k + 1} ) {\int }_{- ∞}^{∞} t \frac{α}{{η}_{k + 1}} {e}^{- α ( t - i {β}_{N} - {β}_{k} )} \cdot {𝕀}_{[ i {β}_{N} + {β}_{k} , i {β}_{N} + {β}_{k + 1} ]} ( t ) dt . \qquad ( 17 )$$

The complementary cumulative distribution function can be written as:

$$P ( \{ T > τ \} ) = {\int }_{τ}^{∞} {f}_{T} ( t ) dt = {\sum }_{i = 0}^{∞} {p}^{i} {\sum }_{k = 0}^{N - 1} P ( {E}_{k + 1} ) {\int }_{τ}^{∞} \frac{α}{{η}_{k + 1}} {e}^{- α ( t - i {β}_{N} - {β}_{k} )} \cdot {𝕀}_{[ i {β}_{N} + {β}_{k} , i {β}_{N} + {β}_{k + 1} ]} ( t ) dt , \qquad ( 18 )$$

where τ is a time threshold.

The expected value [symbol] [T] and the complementary cumulative distribution P({T>τ}) can be optimized as now discussed. The expected value [symbol] [T] can be optimized as a function of [symbol] ₁, . . . , [symbol] _{N-1} when ρ is fixed. The optimization problem for the expected value [symbol] [T] and the complementary cumulative distribution P({T>τ}) can be written as:

$${min}_{{R}_{1} , … , {R}_{N - 1}} f ( {R}_{1} , ... , {R}_{N} ) \qquad ( 19 )$$

$$subject to$$

$$i ) 0 < {R}_{1} < {R}_{2} < ⋯ < {R}_{N - 1} < {R}_{N} , i = 1 , 2 , … , N ,$$

$$ii ) ρ = {ρ}_{0} ,$$

$$iii ) {P}_{R} = {P}_{0} ,$$

where N is selected by the user, f( [symbol] ₁, . . . , [symbol] _{N}) is either [symbol] [T] or P ({T>τ}), P_{R} is the received signal power, and ρ₀ and P₀ are constants.

The optimization is not performed as a function of ρ, and the smallest possible value of ρ (which is ρ₀) is chosen for scanning. This is because enlarging ρ results in a further decrease in an already small probability of detection P_{D}, and instead of saving time by scanning with a larger beam radius, a larger time is incurred whenever ρ>ρ₀ (due to a poorer P_{D}). In one application, for the purpose of a global optimization, a real-number genetic algorithm is used to find the minimum of the objective function. As a result of this solution, instead of having a same difference B between consecutive radiuses of the uncertainty regions [symbol] ( [symbol] ₖ), as illustrated in FIG. 5A, the radius difference B varies from region to region, as illustrated in FIG. 5B. This radius difference B varies based on one or more of (1) the standard deviation a of the receiver's position 234 inside the uncertainty region 232, (2) the beam 212's radius ρ, (3) the dwell time T_{d}, and/or (4) the time threshold τ.

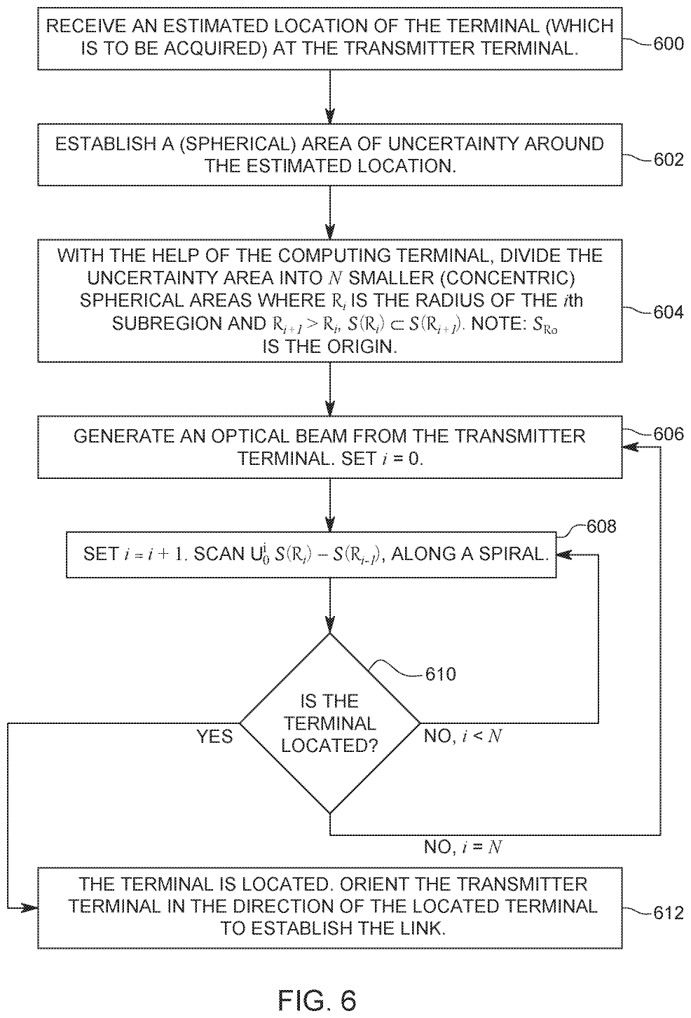

A method for aligning the terminal 210 with another terminal 220 for establishing an optical link is now discussed with regard to FIG. 6. The method incudes a step 600 of receiving at the terminal 210, an estimated location of the another terminal 230, a step 602 of establishing an area of uncertainty (preferably spherical) around the estimated location of the another terminal, a step 604 of dividing, with a computing device of the terminal 210, the area of uncertainty into N (where N is between 2 and 20) smaller areas, one spherical region S(R₁) and an annulus ring S(R₂)−S(R₁), wherein each of S(R₁) and S(R₂) are spherical regions with radii R₂>R₁, a step 606 of generating an optical beam 212 with a transmitter 412 of the terminal 210, a step 608 of setting an index “i” at an initial value and scanning the first region S(R₁) to locate the another terminal, a step 610 of determining whether the another terminal is located, repeating the step 608 if the another terminal is not located, but this time scanning again the spherical region S(R₁) and the annulus ring S(R₂)−S(R₁) with the optical beam 212, and a step 612 of orienting the terminal 210 toward the another terminal 220, based on the detected position of the other terminal, to establish the optical link. If all the iterations i have been performed and the another terminal has not been detected, the process returns to step 606.

In one application, the steps of scanning and scanning again direct the optical beam along corresponding spirals located within the spherical region [symbol] ( [symbol] ₁) and the annulus ring [symbol] ( [symbol] ₂)− [symbol] ( [symbol] ₁), respectively. The radii [symbol] ₁ and [symbol] ₂ are selected to minimize an expected value [symbol] [7] of an acquisition time T of the another terminal. The method may further include dividing the area of uncertainty 232 into the one spherical region [symbol] ( [symbol] ₁), the annulus ring [symbol] ( [symbol] ₂)− [symbol] ( [symbol] ₁), and another annulus ring [symbol] ( [symbol] ₃)− [symbol] ( [symbol] ₂). The method also may include selecting a zero-mean Gaussian distribution to describe a location of the another terminal in the area of uncertainty. The zero-mean Gaussian distribution is characterized by a standard deviation σ. In one application, a radius difference B between two adjacent regions [symbol] ( [symbol] ₁) and [symbol] ( [symbol] ₂) of the area of uncertainty 232 depends on (1) the standard deviation a of the another receiver position inside the uncertainty region, (2) an optical beam radius ρ, and (3) a dwell time T_{d}, which describes a time interval between two consecutive optical beams sent along a given path inside one of the two adjacent regions. The radius difference between the first and second spherical regions [symbol] ( [symbol] ₁) and [symbol] ( [symbol] ₂) is different than a radius difference between the second spherical region [symbol] ( [symbol] ₂) and a third spherical region [symbol] ( [symbol] ₃), which is also part of the area of uncertainty.

The method may further include a step of receiving at a radio-frequency (RF) unit an RF signal from the another terminal when the another terminal receives the optical beam, and a step of aligning with a positioning system the optical transmitter with the another terminal to establish the optical link.

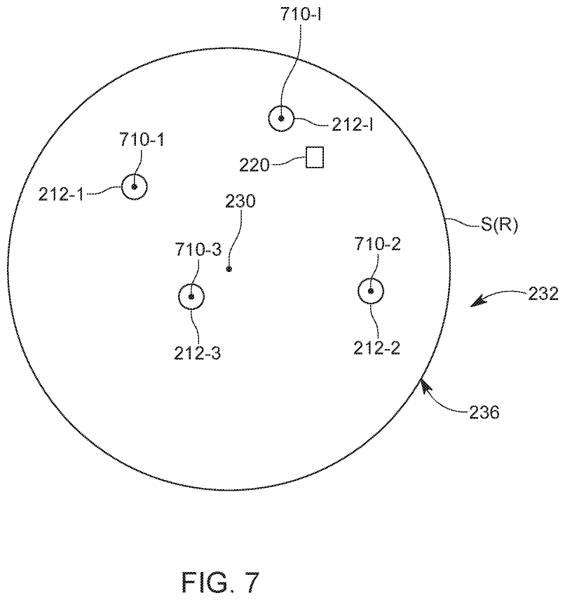

The above discussed adaptive spiral search method may be replaced with another novel method, which is called herein the “shotgun” method. The shotgun acquisition method is a randomized acquisition technique that involves, as illustrated in FIG. 7, firing the uncertainty region [symbol] ( [symbol] ) with signal pulses 212-I at certain locations 710-I in the region 232, where the locations 710-I are selected according to a zero-mean Gaussian distribution in two dimensions. The Gaussian distribution is called herein the “firing distribution.” The mean acquisition time and the complementary cumulative distribution function of the acquisition time for the shotgun approach are now introduced.

Let [symbol] be the event indicating that the beam 212 falls inside a ball of radius ρ that contains the receiver 220. For the sake of analysis, it is assumed that the receiver 220 is located at a point (x, y) inside the uncertainty region 232. Let [symbol] _{ρ}(x,y) be such a ball of radius ρ centered around (x, y). It is further assumed that when the beam center falls inside [symbol] _{ρ}(x, y), the detector 220 is completely covered by the beam 212, and there is a chance of detection. In this case, the probability of occurrence of [symbol] , given that the receiver 220 is located at (x, y), is given by:

$$P ( B \vert x , y ) = \int {\int }_{{B}_{ρ} ( x , y )} \frac{1}{2 π {σ}_{0}^{2}} {e}^{- ( \frac{{x}^{2} + {y}^{2}}{2 {σ}_{0}^{2}} )} dxdy , \qquad ( 20 )$$

where σ₀² is the variance of the firing distribution. For the practical case of ρ<<σ₀, the expression (20) becomes:

$$P ( B \vert x , y ) \approx \frac{π {ρ}^{2}}{2 π {σ}_{0}^{2}} {e}^{- ( \frac{{x}^{2} + {y}^{2}}{2 {σ}_{0}^{2}} )} = \frac{{ρ}^{2}}{2 {σ}_{0}^{2}} {e}^{- ( \frac{{x}^{2} + {y}^{2}}{2 {σ}_{0}^{2}} )} . \qquad ( 21 )$$

If the probability of detection of the receiver when one shot is fired in the uncertainty region is p_{D}(x,y), then its value is:

p_{D}(x,y)=P( [symbol] |x,y)P_{D} (22)

In this case, the acquisition time T has the geometric distribution given by:

$${f}_{T} ( t \vert x , y ) := {\sum }_{l = 1}^{∞} {( 1 - {p}_{D} ( x , y ) )}^{l - 1} {p}_{D} ( x , y ) δ ( t - l {T}_{d} ) , \qquad ( 23 )$$

which implies that

$$𝔼 [ T \vert x , y ] = \frac{{T}_{d}}{{p}_{D} ( x , y )} .$$

Then, the average acquisition time is:

$$𝔼 [ T ] = {\int }_{- ∞}^{∞} {\int }_{- ∞}^{∞} 𝔼 [ T \vert x , y ] {f}_{X Y} ( x , y ) dxdy = {\int }_{- ∞}^{∞} {\int }_{- ∞}^{∞} \frac{{T}_{d}}{{p}_{D} ( x , y )} \frac{1}{2 π {σ}^{2}} {e}^{- ( \frac{{x}^{2} + {y}^{2}}{2 {σ}^{2}} )} dxdy = \frac{2 {T}_{d} {σ}_{0}^{4}}{{ρ}^{2} {P}_{D} ( {σ}_{0}^{2} - {σ}^{2} )} , \qquad ( 24 )$$

$$for$$

$${σ}_{0} > σ .$$

The average acquisition time is optimized (e.g., minimized) with respect to σ₀. By taking the partial derivative of equation (24) with respect to σ₀, and setting the resulting derivative equal to zero, the following relationship is obtained:

α₀*=\sqrt{2}σ (25)

The complementary cumulative distribution function of T is derived to be as follows:

$$P ( \{ T > τ \} \vert x , y ) = {\int }_{τ}^{∞} {f}_{T} ( t \vert x , y ) dt = {( 1 - {p}_{D} ( x , y ) )}^{max ( 1 , ⌊ \frac{τ}{{T}_{d}} ⌋ 1 + 1 ) - 1} . \qquad ( 26 )$$

If

$$max ( 1 , ⌊ \frac{τ}{{T}_{d}} ⌋ + 1 ) - 1$$

is considered to be n, then

$$n = max ( 0 , ⌊ \frac{τ}{{T}_{d}} ⌋ ) .$$

For a small T_{d}, n can be a very large number, and it becomes very difficult to evaluate equation (26) due to the factor

$$( \begin{matrix}n \\ k\end{matrix} ) ,$$

which is not easy to calculate when n is large and k is moderately large, i.e., k<n. However, all three terms in the sum in equation (26) approach zero when k>>1. Therefore, there is no need to compute the entire sum in equation (26) because the terms in the sum, beyond some integer no, can be ignored when n₀<<n. Thus, with no as the upper limit in the sum, the complementary cumulative distribution can be computed with a small approximation error.

The optimization of the complementary cumulative distribution function is carried out by differentiating equation (26) with respect to σ₀ and setting it equal to zero. However, the solution σ₀*, i.e., the minimizer, has to be computed numerically. Note that the solution σ₀* is a function of both τ and P_{D}.

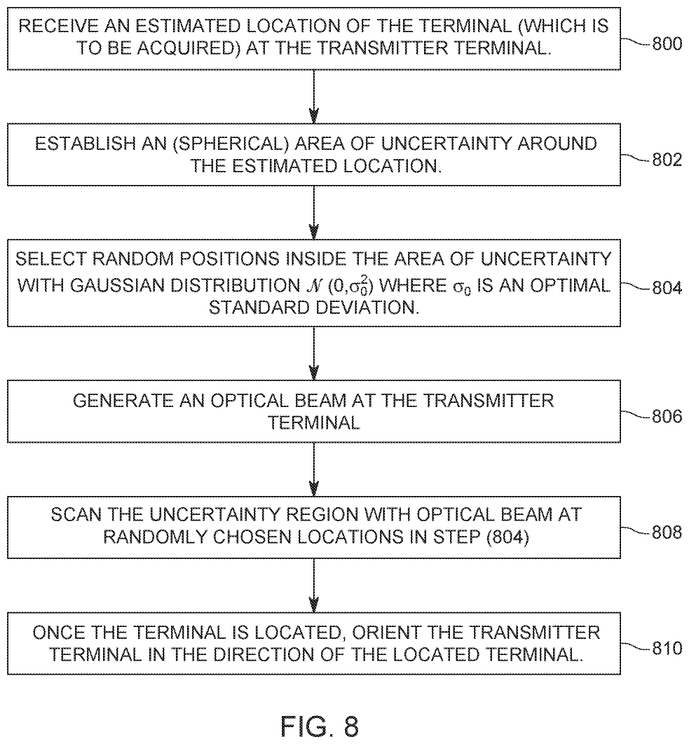

A method for aligning a terminal 210 with another terminal 220 for establishing an optical link is now discussed with regard to FIG. 8. The method includes a step 800 of receiving at the terminal 210, initial information about an estimated location of the another terminal 220, a step 802 of establishing an area of uncertainty 232 (preferably spherical) around the estimated location of the another terminal 220, a step 804 of selecting random positions inside the area of uncertainty, a step 806 of generating an optical beam 212 with a transmitter 412 of the terminal 210, a step 808 of scanning with the optical beam 212 the uncertainty region at the random positions to locate the another terminal, and a step 810 of orienting the terminal 210 toward the another terminal 220 to establish the optical link, based on the detected position. In one application, the random positions are selected based on a Gaussian distribution having a standard deviation σ°.

To compare the performance of the adaptive acquisition scheme illustrated in FIGS. 5B and 6 and the shotgun acquisition scheme illustrated in FIGS. 7 and 8, the number of signal photons detected during the observation interval is fixed at 25, and the number of noise photons is varied between 13 and 24. These photon counts result from the following system parameters: the received signal intensity is 6×10⁻⁸ Joules/square meters/second, the average noise intensity is 4×10⁻⁸ Joules/square meters/second, the area of the detector 410 is 1 square centimeter, the wavelength of the used light is 1550 nanometers, the pulse duration is 1 microsecond, and the photoconversion efficiency is 0.5. By using these parameter values in equation (4), and choosing an appropriate threshold τ, the probability of detection is calculated to lie between 0.02 and 0.08, while the probability of false alarm is fixed at 1×10⁻¹².

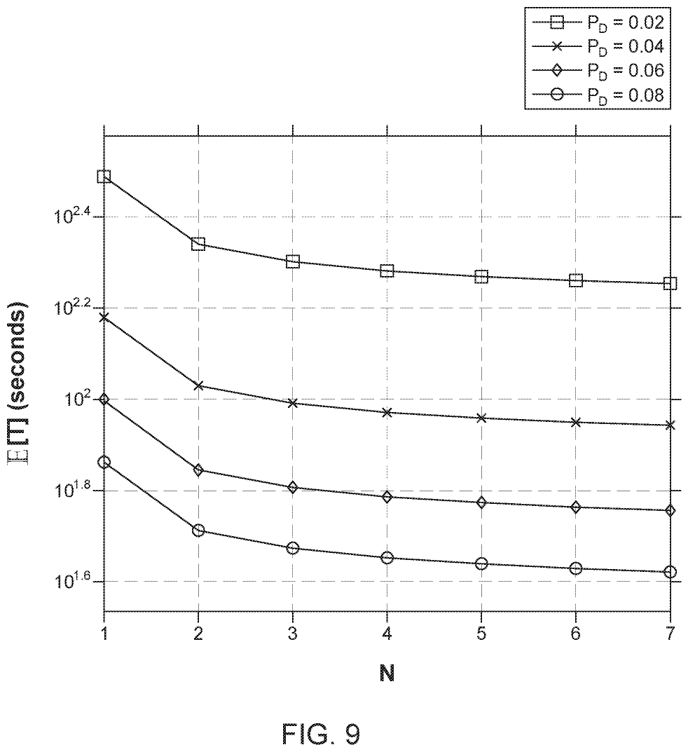

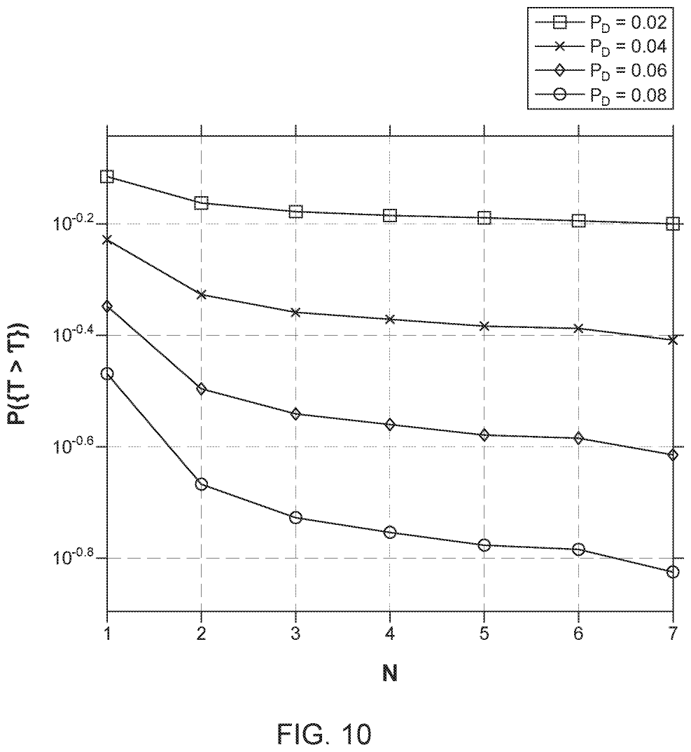

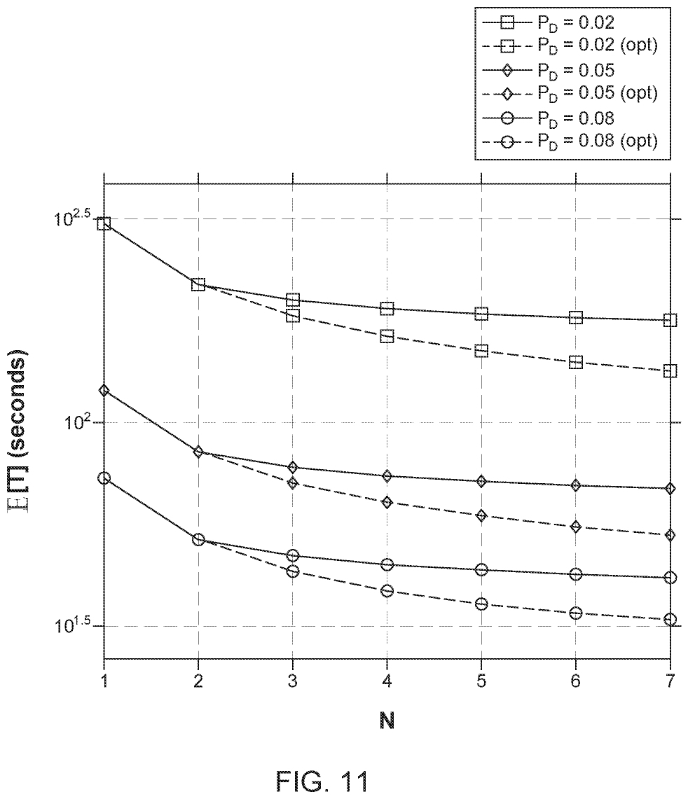

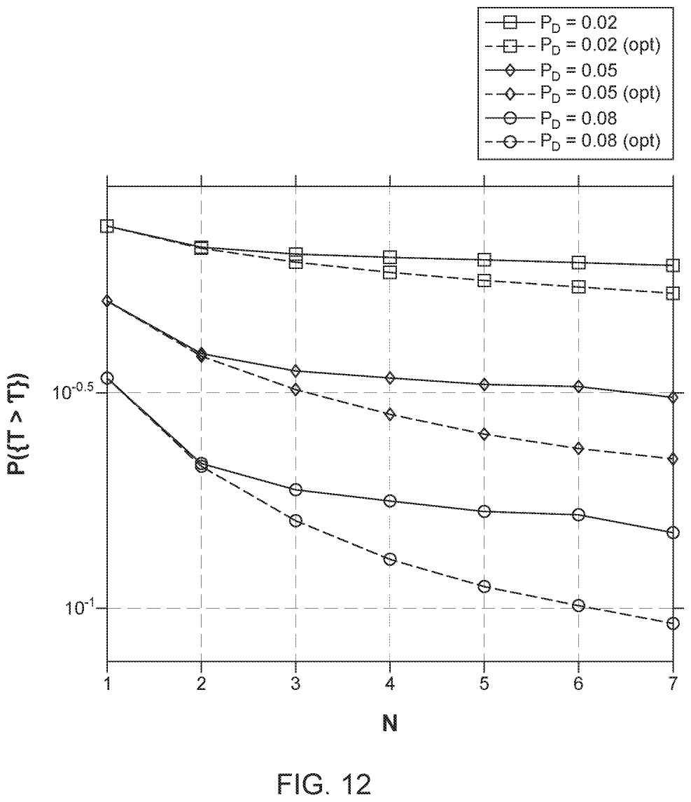

FIGS. 9 and 10 show the expected acquisition time and the complementary cumulative distribution function (ccdf) of the acquisition time, respectively, as a function of number of subregions N for the adaptive spiral search scheme. The curves in these figures correspond to the uniform spacing between the radii [symbol] ᵢ, i.e., constant distance B, as shown in FIG. 5A, which is the non-optimized scenario. It can be seen that the acquisition performance improves with N. However, as can be observed from these curves, the law of diminishing return takes effect when N grows. FIGS. 11 and 12 depict the gain in performance achieved by optimization of the radii of the subregions, i.e., the distance B between the radii of the various regions changes, as illustrated in FIG. 5B. As can be seen from these figures, the performance gains can be significant when N is large. For all these figures, the radius of the uncertainty region has been selected to be 50 m, the standard deviation σ is 15 m, the beam radius ρ is 0.2 m, the dwell time T_{d} is 0.1 ms, and the time threshold τ is 80 seconds. Note that the N=1 case corresponds to the regular spiral search. Thus, for the adaptive spiral search, N>1. Note that N cannot be chosen to be arbitrarily large because the optimization of the radii [symbol] ᵢ becomes computationally expensive for a large number of radii. As can be inferred from FIGS. 11 and 12, the performance gains with the optimization of the acquisition time for a smaller N yields better results as compared to the non-optimized case when N is large. The maximum value selected by the inventors for these tests was N=7 for both the optimized and nonoptimized scenarios.

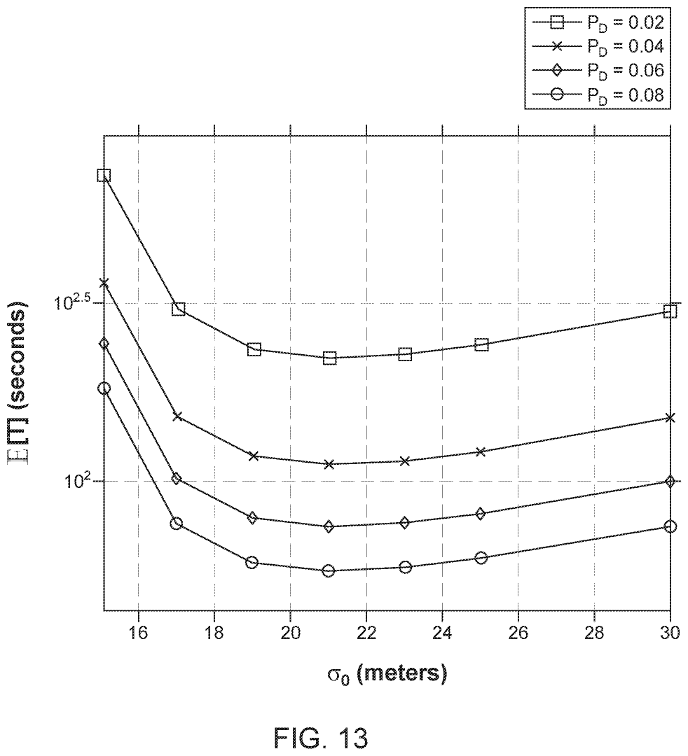

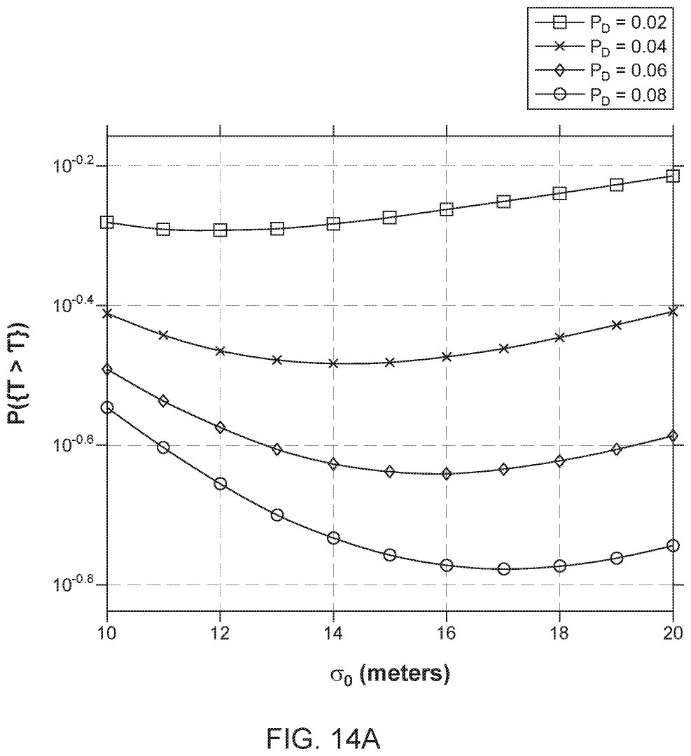

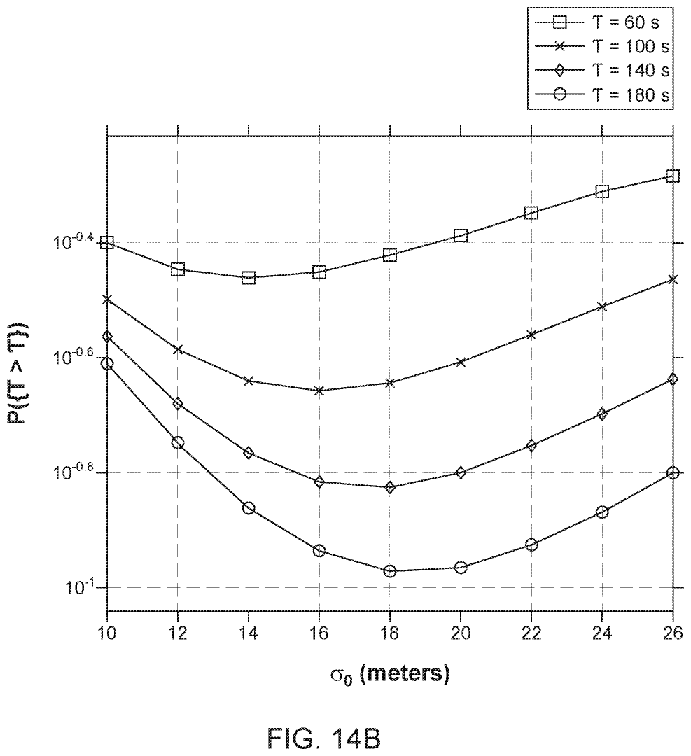

FIGS. 13 to 14B illustrate the average acquisition time and the complementary cumulative distribution function, respectively, for the shotgun approach as a function of the standard deviation of the firing distribution. It is noted that the optimal value σ₀* is a function of P_{D} as well as T in the case of the complementary cumulative distribution function, whereas σ₀* is independent of P_{D} for the mean acquisition time scenario (see FIG. 13). Note that FIG. 13 uses the radius of the uncertainty region to be 50 m, the standard deviation of the receiver's position inside the uncertainty region σ is 15 m, the beam radius ρ is 0.2 m, the dwell time is 0.1 ms, and the optimal value for σ₀ is 21.21 m. For FIG. 14A, the time threshold τ is 80 s and for FIG. 14B the probability of detection P_{D} is 0.05. The radius of uncertainty for both cases is 50 m, the standard deviation is 15 m, the beam radius is 0.2 m, and the dwell time is 0.1 ms.

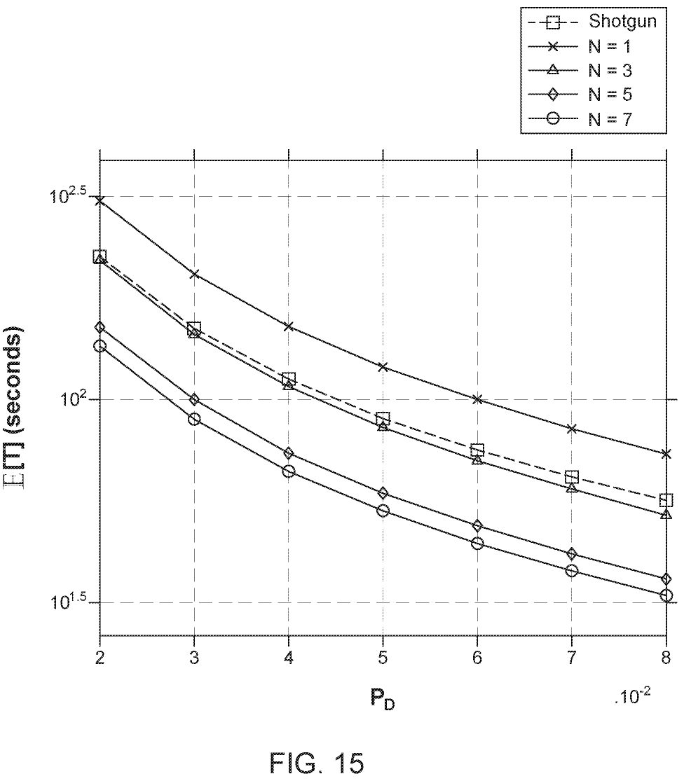

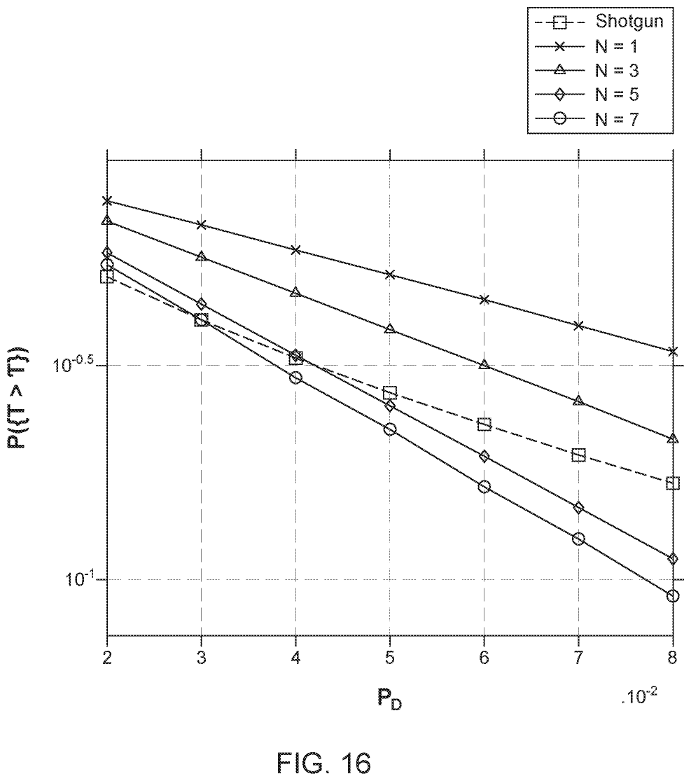

FIGS. 15 and 16 illustrate the difference in performance between the shotgun approach and the adaptive spiral scheme as a function of P_{D}. Both schemes are optimized to give the best possible performance. As can be seen from these figures, the shotgun approach gives a better performance than the N=1 and N=2 scenarios from the perspective of complementary cumulative distribution function, but is outperformed by larger N for the adaptive spiral search for higher P_{D}.

Even though the shotgun approach does not perform as well as the adaptive spiral search for a larger N, this approach is still desirable from two point of views. First, it is worth to remember that for the spiral acquisition, the method traces a spiral for each region while scanning the uncertainty region. This tracing action requires a very high pointing accuracy on the transmitter's part. In a real system, there is always a pointing error tolerance limit within which the transmitter system operates, and if the magnitude in error is significant, the performance of the adaptive spiral search can be seriously degraded. More specifically, if the transmitter misses the receiver due to the pointing error, it will have to scan an entire subregion before it gets a chance to shine light again on the receiver. On the other hand, the pointing error is not such a serious problem for the shotgun approach because the pointing error only results in slightly increasing the uncertainty volume (assuming that the GPS localization error and the transmitter's pointing error are independent random variables).

In addition to a need for higher pointing accuracy, the optimization cost (cost of executing a real-number genetic algorithm in a multidimensional space) for the adaptive spiral search may also make it a less suitable choice. On the other hand, the optimization of the average acquisition time as a function of the σ₀ is easy to be carried out for the shotgun approach. However, the task of optimization for the complementary cumulative distribution function for the shotgun scheme may be more computationally intensive.

From these simulations, it can be concluded that both the adaptive spiral search, and the shotgun approach perform better than the regular spiral search scheme for the low probability of detection scenario. For a large number of subregions N, the adaptive spiral search outperforms the shotgun technique. However, in order to gain a better performance, the adaptive search spiral requires precise pointing by the transmitter in order to scan the region of uncertainty. Additionally, the optimization of the adaptive spiral search using a genetic algorithm may also incur additional complexity overhead.

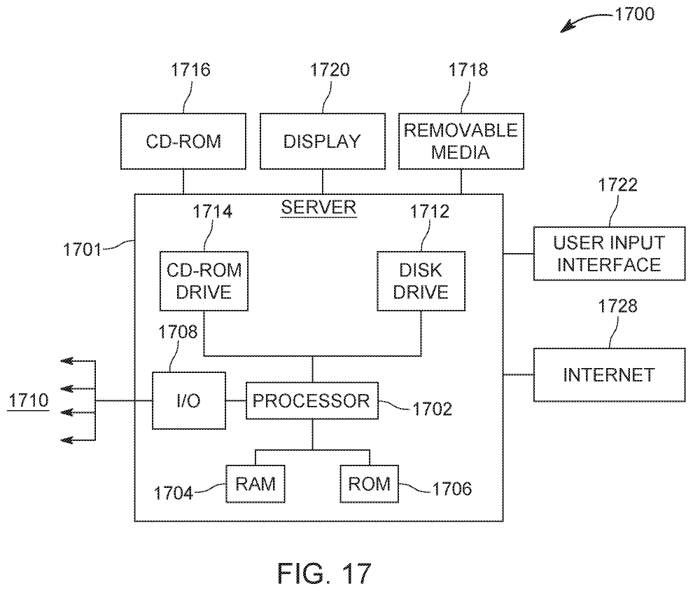

The methods discussed above can be run into the processor 414 of the terminal 210/220 shown in FIG. 4. Hardware, firmware, software or a combination thereof may be used to perform the various steps and operations described herein. The processor 414 and associated memory 416 in FIG. 4 may be implemented as the computing device 1700 illustrated in FIG. 17.

Computing device 1700 suitable for performing the activities described in the exemplary embodiments may include a server 1701. Such a server 1701 may include a central processor (CPU) 1702 coupled to a random access memory (RAM) 1704 and to a read-only memory (ROM) 1706. ROM 1706 may also be other types of storage media to store programs, such as programmable ROM (PROM), erasable PROM (EPROM), etc. Processor 1702 may communicate with other internal and external components through input/output (I/O) circuitry 1708 and bussing 1710 to provide control signals and the like. Processor 1702 carries out a variety of functions as are known in the art, as dictated by software and/or firmware instructions.

Server 1701 may also include one or more data storage devices, including hard drives 1712, CD-ROM drives 1714 and other hardware capable of reading and/or storing information, such as DVD, etc. In one embodiment, software for carrying out the above-discussed steps may be stored and distributed on a CD-ROM or DVD 1716, a USB storage device 1718 or other form of media capable of portably storing information. These storage media may be inserted into, and read by, devices such as CD-ROM drive 1714, disk drive 1712, etc. Server 1701 may be coupled to a display 1720, which may be any type of known display or presentation screen, such as LCD, plasma display, cathode ray tube (CRT), etc. A user input interface 1722 is provided, including one or more user interface mechanisms such as a mouse, keyboard, microphone, touchpad, touch screen, voice-recognition system, etc.

Server 1701 may be coupled to other devices, such as sources, detectors, etc. The server may be part of a larger network configuration as in a global area network (GAN) such as the Internet 1728, which allows ultimate connection to various landline and/or mobile computing devices.

The disclosed embodiments provide a terminal that is configured to search for another terminal in a given volume for establishing an optical communication link. The terminal uses an adaptive spiral search or a shotgun approach as discussed herein. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
[1] J. Wang, J. M. Kahn, and K. Y. Lau, “Minimization of acquisition time in short-range free-space optical communication,” Applied Optics, vol. 41, no. 36, December 2002.
[2] X. Li, S. Yu, J. Ma, and L. Tan, “Analytical expression and optimization of spatial acquisition for intersatellite optical communications,” Optics Express, vol. 19, no. 3, pp. 2381-2390, January 2011.
[3] M. S. Bashir and M. -S. Alouini, “Signal acquisition with photon-counting detector arrays in free-space optical communications,” IEEE Transactions on Wireless Communications, November 2019, accepted for publication (available on arXiv at https://arxiv.org/pdf/1912. 10586.pdf).

1. A terminal configured to communicate with another terminal using an optical link, the terminal comprising:
an optical transmitter configured to emit an optical beam;
an optical receiver configured to receive an optical signal; and
a computing device configured to control the optical transmitter and to receive the optical signal from the optical receiver,
wherein the computing device is configured to establish the optical link with the another terminal by,
(1) dividing an area of uncertainty, where the another terminal is located, into one spherical region [symbol] ( [symbol] ₁) and an annulus ring [symbol] ( [symbol] ₂)− [symbol] ( [symbol] ₁), wherein each of [symbol] ( [symbol] ₁) and [symbol] ( [symbol] ₂) are spherical regions with radii [symbol] ₂> [symbol] ₁,
(2) scanning first the spherical region [symbol] ( [symbol] ₁) with the optical beam (212), and
(3) scanning second the spherical region [symbol] ( [symbol] ₁) and the annulus ring [symbol] ( [symbol] ₂)− [symbol] ( [symbol] ₁) with the optical beam.

2. The terminal of claim 1, wherein the computing device is configured to scan each of the spherical regions [symbol] ( [symbol] ₁) and [symbol] ( [symbol] ₂) along a spiral.

3. The terminal of claim 1, wherein the radii [symbol] ₁ and [symbol] ₂ are selected to minimize an expected value [symbol] [T] of an acquisition time T of the another terminal.

4. The terminal of claim 1, wherein the area of uncertainty is divided into the one spherical region [symbol] ( [symbol] ₁), the annulus ring [symbol] ( [symbol] ₂)− [symbol] ( [symbol] ₁), and another annulus ring [symbol] ( [symbol] ₃)− [symbol] ( [symbol] ₂).

5. The terminal of claim 1, wherein an uncertainty of a location of the another terminal in the area of uncertainty is described by a zero-mean Gaussian distribution.

6. The terminal of claim 5, wherein the zero-mean Gaussian distribution is characterized by a standard deviation σ.

7. The terminal of claim 6, wherein a radius difference B between two adjacent regions [symbol] ( [symbol] ₁) and [symbol] ( [symbol] ₂) of the area of uncertainty depends on (1) the standard deviation σ of the another receiver position inside the uncertainty region, (2) a radius ρ of the optical beam, and (3) a dwell time T_{d}, which describes a time interval between two consecutive optical beams sent along a given path inside one of the two adjacent regions.

8. The terminal of claim 1, wherein a radius difference between the first and second spherical regions [symbol] ( [symbol] ₁) and [symbol] ( [symbol] ₂) is different than a radius difference between the second spherical region [symbol] ( [symbol] ₂) and a third spherical region [symbol] ( [symbol] ₃), which is also part of the area of uncertainty.

9. The terminal of claim 1, further comprising:
a positioning system configured to align the optical transmitter with the another terminal; and
a radio-frequency (RF) unit configured to receive an RF signal from the another terminal when the another terminal receives the optical beam.

10. A method for aligning a terminal with another terminal for establishing an optical link, the method comprising:
receiving at the terminal an estimated location of the another terminal;
establishing an area of uncertainty around the estimated location of the another terminal;
dividing, with a computing device of the terminal, the area of uncertainty into one spherical region [symbol] ( [symbol] ₁) and an annulus ring [symbol] ( [symbol] ₂)− [symbol] ( [symbol] ₁), wherein each of [symbol] ( [symbol] ₁) and [symbol] ( [symbol] ₂) are spherical regions with radii [symbol] ₂> [symbol] ₁;
generating an optical beam with a transmitter of the terminal;
scanning with the optical beam only the spherical region [symbol] ( [symbol] ₁) to locate the another terminal;
scanning again the spherical region [symbol] ( [symbol] ₁) and the annulus ring [symbol] ( [symbol] ₂)− [symbol] ( [symbol] ₁) with the optical beam to determine an actual location of the another terminal; and
orienting the terminal toward the another terminal, based on the actual location, to establish the optical link.

11. The method of claim 10, wherein the steps of scanning and scanning again direct the optical beam along corresponding spirals located within the spherical region [symbol] ( [symbol] ₁) and the annulus ring [symbol] ( [symbol] ₂)− [symbol] ( [symbol] ₁), respectively.

12. The method of claim 10, wherein the radii [symbol] ₁ and [symbol] ₂ are selected to minimize an expected value [symbol] [T] of an acquisition time T of the another terminal.

13. The method of claim 10, further comprising:
dividing the area of uncertainty into the one spherical region [symbol] ( [symbol] ₁), the annulus ring [symbol] ( [symbol] ₂)− [symbol] ( [symbol] ₁), and another annulus ring [symbol] ( [symbol] ₃)− [symbol] ( [symbol] ₂).

14. The method of claim 10, further comprising:
selecting a zero-mean Gaussian distribution to describe a location of the another terminal in the area of uncertainty.

15. The method of claim 14, wherein the zero-mean Gaussian distribution is characterized by a standard deviation σ.

16. The method of claim 15, wherein a radius difference B between two adjacent regions [symbol] ( [symbol] ₁) and [symbol] ( [symbol] ₂) of the area of uncertainty depends on (1) the standard deviation σ of the another receiver position inside the uncertainty region, (2) a radius ρ of the optical beam, and (3) a dwell time T_{d}, which describes a time interval between two consecutive optical beams sent along a given path inside one of the two adjacent regions.

17. The method of claim 10, wherein a radius difference between the first and second spherical regions [symbol] ( [symbol] ₁) and [symbol] ( [symbol] ₂) is different than a radius difference between the second spherical region [symbol] ( [symbol] ₂) and a third spherical region [symbol] ( [symbol] ₃), which is also part of the area of uncertainty.

18. The method of claim 10, further comprising:
receiving at a radio-frequency (RF) unit an RF signal from the another terminal when the another terminal receives the optical beam; and
aligning with a positioning system the optical transmitter with the another terminal to establish the optical link.

19. A method for aligning a terminal with another terminal for establishing an optical link, the method comprising:
receiving at the terminal an estimated location of the another terminal;
establishing an area of uncertainty around the estimated location of the another terminal;
selecting random positions inside the area of uncertainty;
generating an optical beam with a transmitter of the terminal;
scanning with the optical beam the random positions to determine an actual location of the another terminal; and
orienting the terminal toward the another terminal to establish the optical link, based on the actual position of the another terminal.

20. The method of claim 19, wherein the random positions are selected based on a Gaussian distribution.
